(19) United States
(12) Patent Application Publication
(10) Pub. No.: US 2008/0065574 A1
(43) Pub. Date: Mar. 13, 2008

(54) Adaptive database management and monitoring

(75) Inventor: Luke Hu, Hong Kong (HK)

Correspondence Address: KIRKPATRICK & LOCKHART PRESTON GATES ELLIS LLP, 535 SMITHFIELD STREET, PITTSBURGH, PA, 15222, US

(73) Assignee: Morgan Stanley, New York, NY (US)

(21) Appl. No.: 11/899,715

(22) Filed: Sep. 7, 2007

Related U.S. Application Data
(60) Provisional application No. 60/824,925, filed on Sep. 8, 2006.

(51) Int. Cl. G06F 15/18

(52) U.S. Cl. 706/20

(57) ABSTRACT

Systems and methods for adaptive database management and monitoring are disclosed. According to various embodiments, the present invention comprises training a neural network of a classification engine with real time performance data of a database. Once the neural network has been trained, real time performance data for the database may be input to the classification engine. If the classification engine detects a deviation in performance, it may cause an alert to be sent to a database administrator. In addition, the classification engine may send results of its analysis to a host, which posts the results on a web page. Users may provide feedback on the results to a batch relearn entries database or file. The classification may read the batch relearn entries to use in a backpropogation algorithm to update/retrain the neural network of the classification engine.

### PRIORITY CLAIM

This application claims priority to U.S. provisional application Ser. No. 60/824,925, filed Sep. 8, 2006, which is incorporated herein.

### BACKGROUND

The stability and performance of databases is important to data-driven businesses. The current practice of many database administrators to detect deviations in performance of databases is to establish static rules. When a rule is violated, the database administrator is alerted in order to investigate the violation. The problem with this approach is that the rules are static.

### SUMMARY OF THE INVENTION

In one general aspect, the present invention is directed to systems and methods for adaptive database management and monitoring. According to various embodiments, the present invention comprises training a neural network of a classification engine with real time performance data of a database. Once the neural network has been trained, real time performance data for the database may be input to the classification engine. If the classification engine detects a deviation in performance, it may cause an alert to be sent to a database administrator. In addition, the classification engine may send results of its analysis to a host, which posts the results on a web page. Users may provide feedback on the results to a batch relearn entries database or file. The classification may read the batch relearn entries to use in a backpropogation algorithm to update the neural network of the classification engine. Once updated, a relearn status file or database may be updated with the relearn status of the classification engine. This process may run continuously so that the classification engine is constantly being adaptively updated as to the performance of the database.

### DESCRIPTION OF THE FIGURES

Various embodiments of the present invention are described herein by way of example in conjunction with the following figures, wherein:

FIG. 1 is a diagram of a classification engine according to various embodiments of the present invention;

FIG. 2 is a diagram illustrating training of a neural network according to various embodiments of the present invention;

FIG. 3 is a diagram of a system according to various embodiments of the present invention;

FIG. 4 is a diagram illustrating adaptive updating of a neural network according to various embodiments of the present invention; and

FIGS. 5-8 illustrate screen shots according to various embodiments of the present invention.

### DETAILED DESCRIPTION

Various embodiments of the present invention are directed to systems and methods for adaptively managing and monitoring the performance of databases. The databases may store information that is critical to a business or other type of entity. Multiple users may seek access to the database applications they are running. For that reason, it is important to monitor the performance of the databases.

According to various embodiments, as shown in FIG. 1, the system may use a classification engine 10 to classify the performance of the database. The classification engine 10 may be implemented as a computer program to be executed by one or more networked computing devices, such as a server, personal computer, etc. The classification engine 10 may use a neural network 12 for classifying the performance. A neural network is an interconnected group of artificial neurons that uses a mathematical or computational model for information processing based on a connectionist approach to computation. The neural network 12 may be adaptive in that it may change its structure based on feedback as described further below.

When the neural network 12 detects a deviation in performance in the database, it may notify an alert system 18 so that, for example, a network administrator can address the potential problem with the database. The alarm system 18 may be, for example, an email, instant messaging, or web-based based application that provides notice of the detected deviation to the network administrator(s).

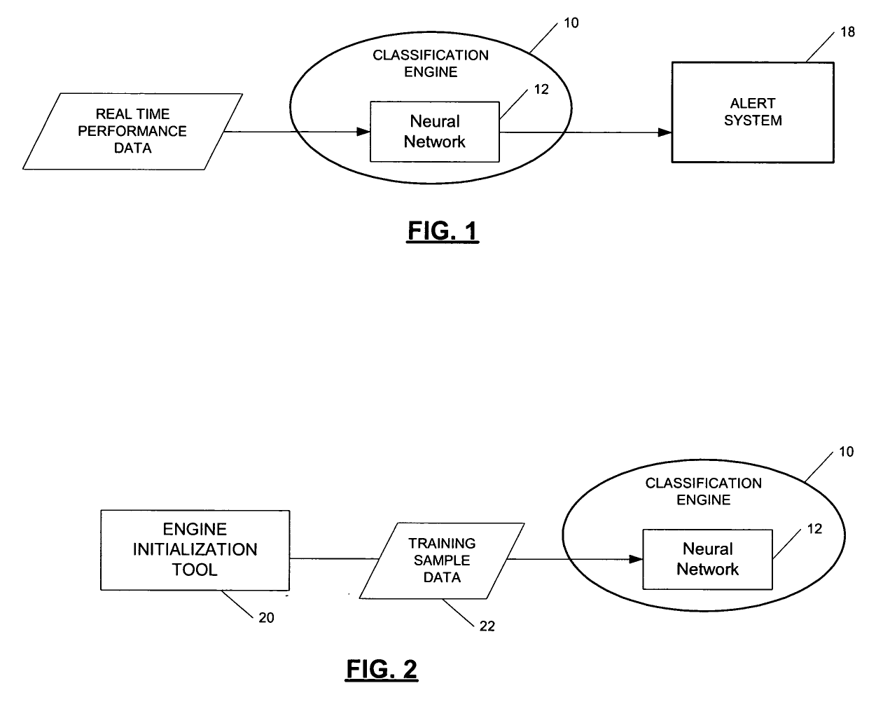

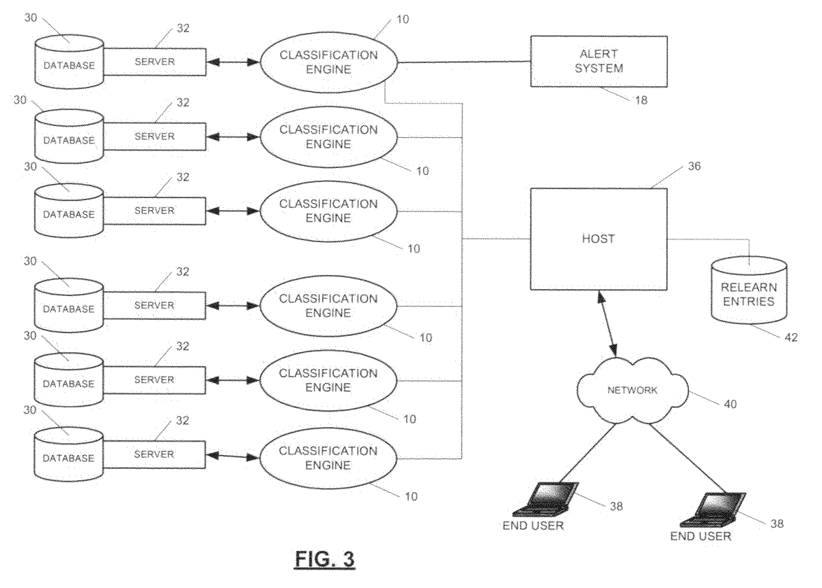

As shown in FIG. 2, before the classification engine 10 can be used to classify the performance of its associated database, the neural network 12 of the classification engine should be trained. According to various embodiments, an engine initialization tool 20 may be used to initialize the neural network 12 with historical database performance data 22. The engine initialization tool 20 may be implemented as a software program to be executed by one or more networked computing devices, such as a server, personal computer, etc. The engine initialization tool 20 may run on the same computer device as the classification engine 10, for example.

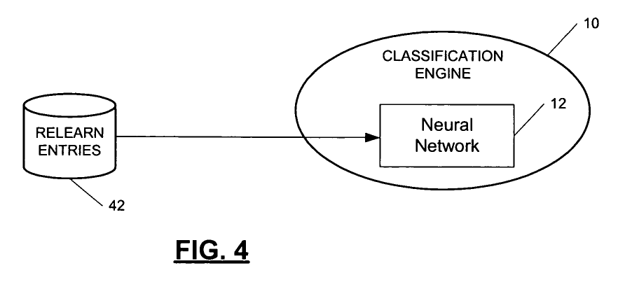

FIG. 3 is a diagram of a database management and monitoring system according to various embodiments of the present invention. As shown in the system of FIG. 3, each database 30 may have an associated server (or servers) 32 for retrieving and serving data in the database 30, and an associated classification engine 10 for patrolling the performance of the database 30. The classification engines 10 may receive performance data for their associated database 30 (as shown in FIG. 1) and analyze that data to detect deviations in performance using the neural networks 12 that are part of each classification engine 10. If a deviation in performance is detected, a message may be sent to the alarm system 18 so that a database administrator may address the situation.

In addition, the classification engines 10 may send the results of their analysis to a host system 36. The host system 36 may host a secure web site which users at client devices 38 can log into via a network 40 to view the results of the analysis. The network 40 may be a WAN, LAN, MAN, the Internet, an intranet, a VPN, or any other suitable communications network comprising wired or wireless communication links. The users 38 may also provide feedback for the classification engine 10 via the web interface. Feedback results from the users 38 may be stored in a relearn entries database 42.

Using a backpropogation algorithm, as shown in FIG. 4, the neural networks 12 may be adaptively updated based on the feedback results in the database 42. Once updated, a relearn status file or database (not shown) may be updated with the relearn status of the classification engine 10. According to various embodiments, the general process of the backpropogation algorithm may comprise: (1) compare the neural network's output for a training sample to the desired output from that sample; (2) calculate the error in each output neuron; (3) for each neuron, calculate what the output should have been, and a scaling factor, how much lower or higher the output must be adjusted to match the desired output (“the local error”); (4) adjust the weights of each neuron to lower the local error; (5) assign “blame” for the local error to neurons at the previous level, giving greater responsibility to neurons connected by stronger weights; and (6) repeat the steps above on the neurons at the previous level, using each one's “blame” as its error.

In addition, a network weighting database or file (not shown) can be employed. The network weighting may be a set of numbers produced as a result of the backpropogation algorithm (e.g., the weights for each neuron), which may be stored in the database or file. The network weightings may represent the ‘knowledge’ accumulated due to the learning of the classifier. The network weightings may be stored in the file or database in order that they may persist over host reboot. With access to the network weightings database (or file), the classifier may reload this knowledge and return to its previous state before host reboot without having to releam it all over again. This process may run continuously so that the classification engine is constantly being adaptively updated as to the performance of the database.

The engine initialization tool 20 (see FIG. 1) may train the neural network 12 with historical database performance. The engine initialization tool 20 may train the neural networks 12 once for each database server 32 (see FIG. 3). Thereafter, the feedback results used in the backpropogation algorithm may retrain the neural networks 12.

Database performance data may be collected by another program which may run, for example, as a Unix process in the host where the database server 32 runs. The database performance data program process may attach to the shared memory used by the database server 32 and take a snap shot of the database activities and then write them to a set of files (e.g., text files) on a periodic basis. These files may then be input to the classification engine 10 (as the activities of the database server 32), thereby allowing the classification engine 10 to perform analysis. The content of the files may consist of user connection information, IO utilization and CPU utilization of each of the users, among other things.

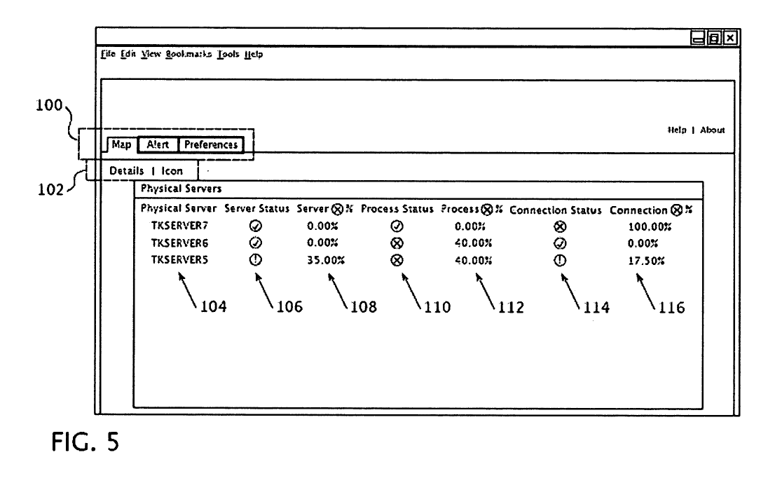

FIGS. 5-8 are screen shots that the host system 36 may provide to the users 38 that show the performance of the databases 30. As shown in the screen shot of FIG. 5, the user interface may comprise a menu bar 100, containing three tabs: Map, Alert, and Preferences. Clicking on the “Map” tab provides an overview of all of the servers 32 being monitored. According to various embodiments, there may be two views in the “Map” mode: a “Details” view and an “Icon” view. The view can be selected by clicking the appropriate link in field 102.

FIG. 5 shows an example of the Details view for the Map mode where three servers are being monitored. In the details view, the name of the servers 32, the status, and deviated entries may be shown. For example, the name of the servers may be shown in column 104, the server status may be shown in column 106, the deviated entries for the servers may be shown in column 108, the process status may be shown in column 110, the deviated entries for the servers may be shown in column 112, the connection status may be shown in column 114, and the deviation entries for connection status may be shown in column 116.

As shown in the example of FIG. 5, according to various embodiments, icons may be used to indicate the status. For example, the following icons may be used:

| SYMBOL | |
|---|---|
| IMAGE | SYMBOL DEFINITION |
| ✓ | There is no deviated entry found in the last 24 hours for this |
| | view. |
| ! | Deviated entries in the last 24 hours for this view by the latest |
| | one is found to be normal. |
| [symbol] | The latest entry for this view is found to be deviated. |

Of course, in other embodiments, different, additional, or fewer symbols may be used. Also, the reporting periods for reporting deviations (twenty four hours in the above example) may be different.

The deviated percentage (e.g., columns 108, 112, 116) may show the portion of the deviated entries in the last 24 hours (or some other time period). Also, sorting of the columns (104 to 116) may be performed by clicking on the column heading for the column to be sorted.

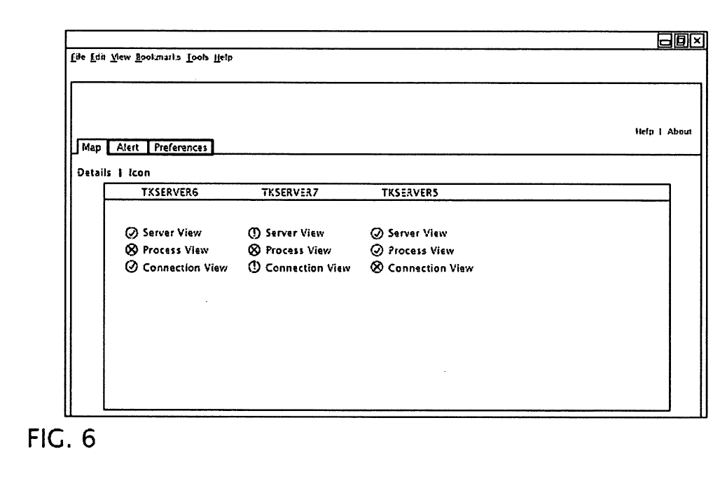

The Icon view, as shown in FIG. 6, may display similar content to that shown in the Details view.

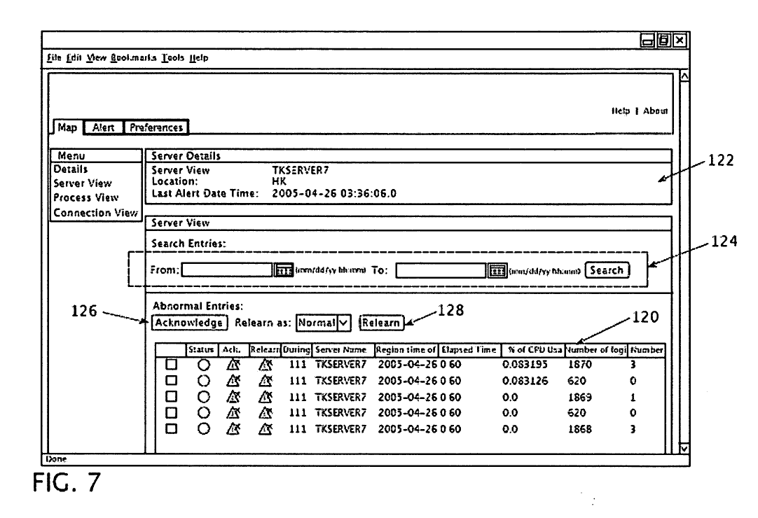

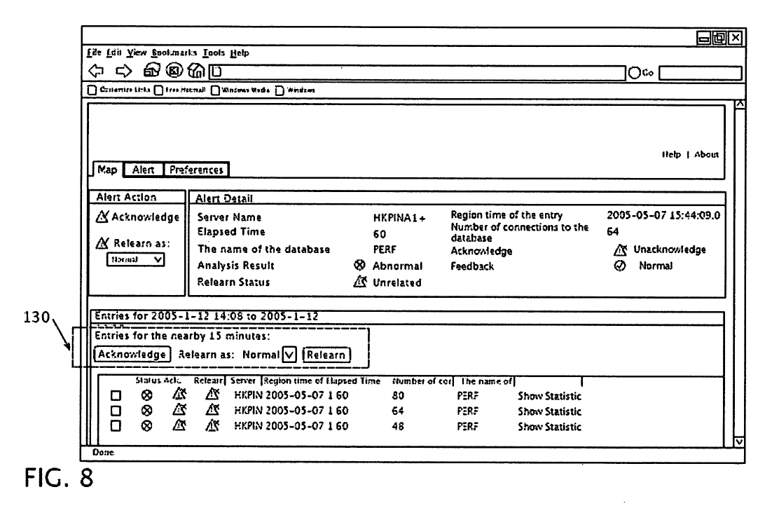

In either the Details view or the Icon view, the user may click on the server name in the Map mode to show details about the particular server. The details view for a particular server, as shown in the example of FIG. 7, may show the latest five (or some other number) deviated entries for each view (e.g., server, process, connection) of the server in a chart 120 and the last alert time in the field 122. The user may also be permitted to search deviated entries in field 124. Also, the user may acknowledge selected deviated entries by clicking the “Acknowledge” tab 126. Further, the user could cause the neural network 12 of the classification engine 10 associated with the server to releam selected entries by clicking the “Releam” tab 128.

By activating the “Alert” mode in menu bar 100, the user may be provided a table showing all of the deviated entries for all servers and arrange them by time. Users may select, according to various embodiments, a time window for the deviated entries, such as the deviated entries found in the last one, two, six, eight, twelve, twenty-four, or forty-eight hours, for example.

By clicking on one of the entries, the user may be presented with specific details regarding the entry, as shown in the example of FIG. 8. Again, a user may choose to acknowledge or have the neural network 12 releam the entry by selecting the appropriate icon in field 130.

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments.

It is to be understood that the figures and descriptions of the embodiments have been simplified to illustrate elements that are relevant for a clear understanding of the embodiments, while eliminating, for purposes of clarity, other elements. For example, certain operating system details and modules of network platforms are not described herein. Those of ordinary skill in the art will recognize, however, that these and other elements may be desirable in a typical processor, computer system or e-mail application, for example. However, because such elements are well known in the art and because they do not facilitate a better understanding of the embodiments, a discussion of such elements is not provided herein.

In general, it will be apparent to one of ordinary skill in the art that at least some of the embodiments described herein may be implemented in many different embodiments of software, firmware and/or hardware. The software and firmware code may be executed by a processor or any other similar computing device. The software code or specialized control hardware which may be used to implement embodiments is not limiting. For example, embodiments described herein may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (non-volatile) memory, an optical disk, magnetic tape, or magnetic disk. Furthermore, at least some of the processes may be programmed when the computer system is manufactured or stored on various types of computer-readable media. Such media may include any of the forms listed above with respect to storage devices and/or, for example, a modulated carrier wave, or otherwise manipulated, to convey instructions that may be read, demodulated/decoded, or executed by a computer or computer system.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semi-permanent and/or semi-temporary. A computer-readable medium may further include one or more data signals transmitted on one or more carrier waves.

A “computer,” “computer system” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component, to perform a given function or functions. Except where such substitution would not be operative, such substitution is within the intended scope of the embodiments. Any servers described herein, for example, may be replaced by a “server farm” or other grouping of networked servers that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

While various embodiments have been described herein, it should be apparent that various modifications, alterations and adaptations to those embodiments may occur to persons skilled in the art with attainment of at least some of the advantages. The disclosed embodiments are therefore intended to include all such modifications, alterations and adaptations without departing from the scope of the embodiments as set forth herein.

What is claimed is:

1. A method for adaptive database management and monitoring comprising:
training a neural network of a classification engine;
inputting performance data for a database into the classification engine;
analyzing the performance data with the neural network; and
detecting a deviation in the performance of the database based on the analysis by the neural network.

2. The method of claim 1, further comprising, after detecting the deviation, sending an alert to a database administrator.

3. The method of claim 2, further comprising:
sending the results of the analysis to a host; and
posting, by the host, the results of the analysis.

4. The method of claim 3, further comprising:
receiving feedback on the posted results;
storing the feedback; and
updating the neural network based on the feedback.

5. The method of claim 4, wherein updating the neural network comprises updating the neural network using a backpropogation algorithm.

6. The method of claim 5, wherein training the neural network with historical database performance data.

7. The method of claim 6, wherein analyzing the performance data comprises analyzing one or more files consisting of information on activities of the database.

8. The method of claim 7, wherein the information on the activities of the database comprises user connection information, IO utilization information, and CPU utilization information.

9. The method of claim 7, further comprising storing weightings from the backpropogation algorithm.

10. An adaptive database management and monitoring system comprising:
a database;
a server in communication with the database; and
a classification engine in communication with the server, wherein the classification engine comprises an adaptive neural network for detecting deviation in the performance of the database.

11. The system of claim 10, wherein the classification engine is for, after detecting the deviation, sending an alert to a database administrator.

12. The system of claim 11, further comprising a host in communication with the classification engine, wherein:
the classification engine is for sending the results of the analysis to the host; and
the host is for posting the results of the analysis.

13. The system of claim 12, wherein the host is further for receiving feedback on the posted results so that the neural network can be updated based on the feedback.

14. The system of claim 13, wherein the neural network is initially trained with historical database performance data.

15. The system of claim 14, wherein neural network is for analyzing the performance data by analyzing one or more files consisting of information on activities of the database.

16. The system of claim 15, wherein the information on the activities of the database comprises user connection information, IO utilization information, and CPU utilization information.

17. An adaptive database management and monitoring system comprising:
a plurality of databases;
a plurality of servers, wherein at least one server is in communication with at least one of the plurality of databases; and
a plurality of classification engines, wherein at least one classification engine is in communication with at least one of the plurality of servers, wherein each of the classification engines comprises an adaptive neural network for detecting deviation in the performance of at least one of the plurality of databases.

18. The system of claim 17, wherein the classification engines are for, after detecting the deviation, sending an alert to a database administrator.

19. The system of claim 18, further comprising a host in communication with the classification engines, wherein:
the classification engines are for sending the results of the analysis to the host; and
the host is for posting the results of the analysis.

20. The system of claim 19, wherein the host is further for receiving feedback on the posted results so that the neural networks can be updated based on the feedback.
